(19) United States
(12) Patent Application Publication
(10) Pub. No.: US 2023/0078041 A1
(43) Pub. Date: Mar. 16, 2023

(54) METHOD OF DISPLAYING ANIMATION, ELECTRONIC DEVICE AND STORAGE MEDIUM

(71) Applicant: BEIJING BAIDU NETCOM SCIENCE TECHNOLOGY CO., LTD., Beijing (CN)

(72) Inventor: Da QU, Beijing (CN)

(73) Assignee: BEIJING BAIDU NETCOM SCIENCE TECHNOLOGY CO., LTD., Beijing (CN)

(21) Appl. No.: 17/975,181

(22) Filed: Oct. 27, 2022

(30) Foreign Application Priority Data
Oct. 28, 2021 (CN) 202111266890.7

(51) Int. Cl. G06T 13/20; G06T 19/20; G06T 17/10; G06T 19/00

(52) U.S. Cl. CPC G06T 13/20; G06T 17/10; G06T 19/003; G06T 19/20; G06T 2219/2012

(57) ABSTRACT

A method of displaying an animation, an electronic device and a storage medium, which relate to a field of a computer technology, in particular to fields of artificial intelligence and augmented reality technologies. The method includes: determining, in response to a scene switching operation for a target scene, a first sampling result corresponding to each vertex of a three-dimensional model according to a first cubic texture object corresponding to the target scene; determining a roaming animation according to a color information of each vertex in a current scene and the first sampling result corresponding to each vertex; and presenting the roaming animation so as to switch the current scene to the target scene.

This application claims priority to Chinese Patent Application No. 202111266890.7, filed on Oct. 28, 2021, which is incorporated herein in its entirety by reference.

### TECHNICAL FIELD

The present disclosure relates to a field of a computer technology, and in particular, to fields of artificial intelligence and augmented reality technologies.

### BACKGROUND

A panorama technology is a virtual reality technology with an important application value. The panorama technology may be implemented to simulate a visual picture when a user is in a certain real scene position, and the panorama technology may enable the user to experience an immersive on-site visual experience with a strong sense of immersion.

### SUMMARY

The present disclosure provides a method of displaying an animation, an electronic device, and a storage medium.

According to an aspect of the present disclosure, a method of displaying an animation is provided, including: determining, in response to a scene switching operation for a target scene, a first sampling result corresponding to each vertex of a three-dimensional model according to a first cubic texture object corresponding to the target scene; determining a roaming animation according to a color information of each vertex in a current scene and the first sampling result corresponding to each vertex; and presenting the roaming animation so as to switch the current scene to the target scene.

According to another aspect of the present disclosure, an electronic device is provided, including: at least one processor; and a memory communicatively connected to the at least one processor, wherein the memory stores instructions executable by the at least one processor, and the instructions, when executed by the at least one processor, cause the at least one processor to implement the method described in embodiments of the present disclosure.

According to another aspect of the present disclosure, a non-transitory computer-readable storage medium having computer instructions therein is provided, and the computer instructions are configured to cause a computer system to implement the method described in embodiments of the present disclosure.

It should be understood that content described in this section is not intended to identify key or important feature in embodiments of the present disclosure, nor is it intended to limit the scope of the present disclosure. Other feature of the present disclosure will be easily understood through the following description.

### BRIEF DESCRIPTION OF THE DRAWINGS

The accompanying drawings are used for better understanding of the solution and do not constitute a limitation to the present disclosure, wherein:

FIG. 1A schematically shows a schematic diagram of a system architecture of a method and an apparatus of displaying an animation, an electronic device and a storage medium according to embodiments of the present disclosure;

FIG. 1B schematically shows a schematic diagram of a three-dimensional model according to embodiments of the present disclosure;

FIG. 2 schematically shows a flowchart of a method of displaying an animation according to embodiments of the present disclosure;

FIG. 3 schematically shows a flowchart of a method of presenting a scene according to embodiments of the present disclosure;

FIG. 4 schematically shows a schematic diagram of determining a sampling result according to embodiments of the present disclosure;

FIG. 5 schematically shows a flowchart of a method of determining a first sampling result corresponding to each vertex of a three-dimensional model according to embodiments of the present disclosure;

FIG. 6 schematically shows a flowchart of a method of determining a roaming animation according to embodiments of the present disclosure;

FIG. 7 schematically shows a schematic diagram of a method of displaying an animation according to embodiments of the present disclosure;

FIG. 8 schematically shows a block diagram of an apparatus of displaying an animation according to embodiments of the present disclosure; and

FIG. 9 schematically shows a block diagram of an exemplary electronic device for implementing embodiments of the present disclosure.

### DETAILED DESCRIPTION OF EMBODIMENTS

Exemplary embodiments of the present disclosure will be described below with reference to accompanying drawings, which include various details of embodiments of the present disclosure to facilitate understanding and should be considered as merely exemplary. Therefore, those of ordinary skilled in the art should realize that various changes and modifications may be made to embodiments described herein without departing from the scope and spirit of the present disclosure. Likewise, for clarity and conciseness, descriptions of well-known functions and structures are omitted in the following description.

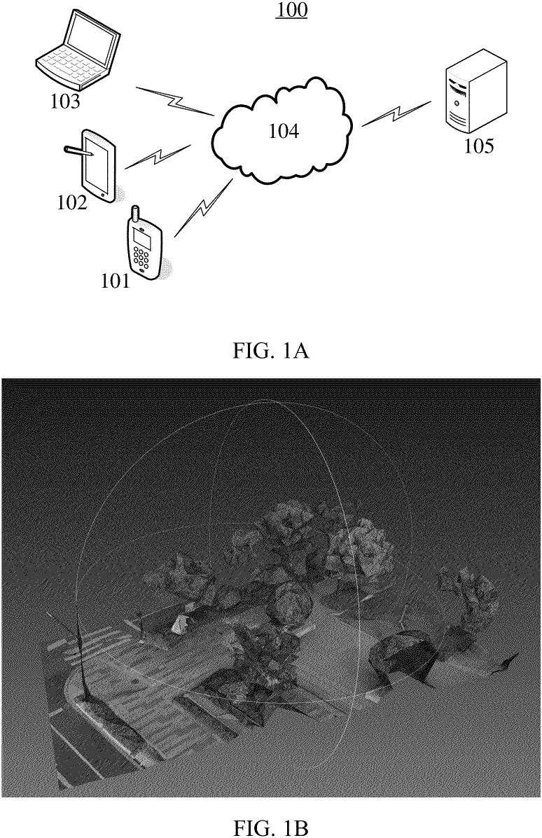

A system architecture of a method and an apparatus provided in the present disclosure will be described below with reference to FIG. 1A.

FIG. 1A schematically shows a schematic diagram of a system architecture of a method and an apparatus of displaying an animation, an electronic device and a storage medium according to embodiments of the present disclosure. It should be noted that FIG. 1 is merely an example of a system architecture to which embodiments of the present disclosure may be applied to help those skilled in the art understand the technical content of the present disclosure, but it does not mean that embodiments of the present disclosure may not be applied to other devices, systems, environments or scenarios.

As shown in FIG. 1A, a system architecture 100 includes terminal devices 101, 102, 103, a network 104, and a server 105. The network 104 is a medium for providing a communication link between the terminal devices 101, 102, 103 and the server 105. The network 104 may include various connection types, such as wired, wireless communication links, optical fiber cables, or the like.

The terminal devices 101, 102, 103 may be used by a user to interact with the server 105 through the network 104 to receive or send messages and the like. The terminal devices 101, 102 and 103 may be installed with various communication client applications, such as shopping applications, web browser applications, search applications, instant messaging tools, email clients, social platform software, etc. (for example only).

The terminal devices 101, 102, 103 may be various electronic devices with display screens and supporting web browsing, including but not limited to smart phones, tablet computers, laptop computers, desktop computers, and the like.

The server 105 may be a server providing various services, such as a background management server (for example only) that provides a support for a website that the user browses using the terminal devices 101, 102, 103 or for an application used by the user with the terminal devices 101, 102, 103. The background management server may analyze and process received data such as a user request, and feed back a processing result (such as a web page, an information, or data acquired or generated according to user request) to the terminal devices.

For example, in such embodiments, the terminal devices 101, 102, 103 may be used by the user to communicate with the server 105 to acquire a three-dimensional model information, an observation point information and a cubic texture information for a certain scene. The terminal devices 101, 102, 103 may render a corresponding three-dimensional model according to the acquired three-dimensional model information, observation point information and cubic texture information, so as to present a panoramic picture of the scene.

According to embodiments of the present disclosure, a panoramic acquisition operation may be performed on a scene to obtain corresponding point cloud data. Then, a three-dimensional model may be synthesized according to the point cloud data. A position of each panoramic acquisition point in the three-dimensional model is relatively fixed. As a three-dimensional model synthesized from the point cloud data has a low texture precision, it is possible to associate a two-dimensional panorama with the three-dimensional model, and attach a high-definition panorama to the three-dimensional model to render a three-dimensional model-based panoramic effect. The panorama may be in a form of cubic texture (CUBE_MAP), for example.

FIG. 1B schematically shows a schematic diagram of a three-dimensional model according to embodiments of the present disclosure. For example, the three-dimensional model as shown in FIG. 1B may be synthesized from point cloud data obtained by performing a panoramic acquisition operation on a street scene. Then, a panoramic effect of the street scene may be rendered by attaching a panorama corresponding to the street scene to the three-dimensional model.

In the technical solution of the present disclosure, an acquisition, a storage, a use, a processing, a transmission, a provision and a disclosure of the three-dimensional model, the scene information, the panoramic picture and other data involved comply with the provisions of relevant laws and regulations, and do not violate the public order and good customs.

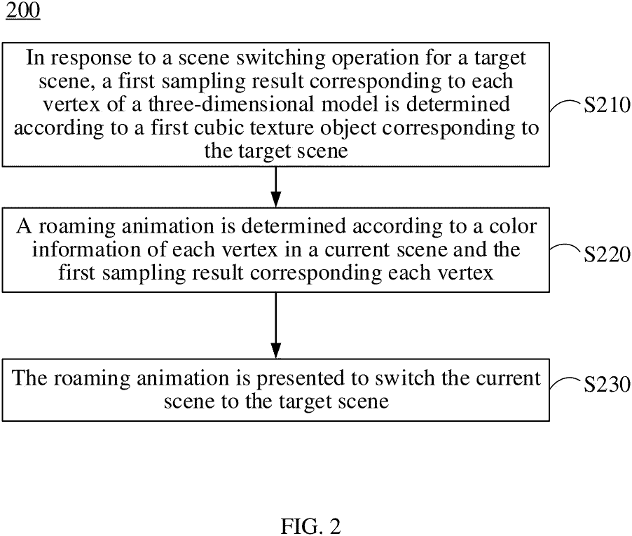

FIG. 2 schematically shows a flowchart of a method of displaying an animation according to embodiments of the present disclosure.

As shown in FIG. 2, a method 200 includes operations S210 to S230.

In operation S210, in response to a scene switching operation for a target scene, a first sampling result corresponding to each vertex of a three-dimensional model is determined according to a first cubic texture object corresponding to the target scene.

According to embodiments of the present disclosure, each scene may correspond to a cubic texture object. The cubic texture object may be used to indicate a color information of each vertex of the three-dimensional model for the scene, and a texture of the three-dimensional model may be set according to the cubic texture object. In such embodiments, the first cubic texture object may be a cubic texture object corresponding to the target scene.

According to embodiments of the present disclosure, for each vertex, sampling may be performed in the first cubic texture object so as to obtain the first sampling result. The first sampling result may be a color information for indicating the corresponding vertex.

In operation S220, a roaming animation is determined according to a color information of each vertex of the three-dimensional model for a current scene and the first sampling result corresponding to each vertex.

According to embodiments of the present disclosure, according to the color information of each vertex in the current scene and the corresponding first sampling result for each vertex, a color-mixing may be performed on a texture for the current scene and a texture for the target scene based on a time progress so as to obtain the roaming animation.

In operation S230, the roaming animation is presented to switch the current scene to the target scene.

According to embodiments of the present disclosure, by presenting the roaming animation, the color of each vertex may be gradually converted to the color indicated by the first sampling result, so as to transition the current scene to the target scene. The transition process is smooth and a user experience may be improved.

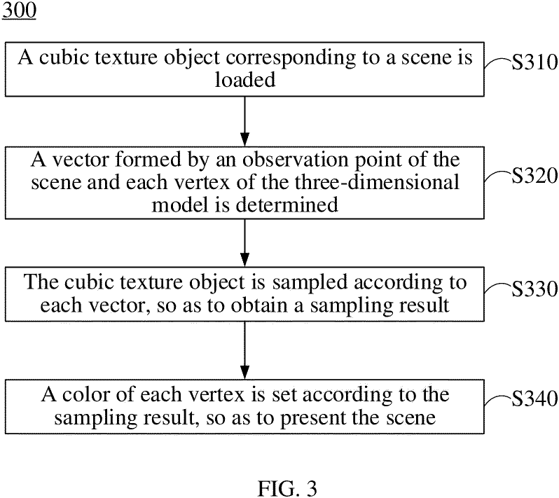

A method of presenting a scene of embodiments of the present disclosure will be described below with reference to FIG. 3. The scene includes but is not limited to the above-mentioned current scene and target scene.

FIG. 3 schematically shows a flowchart of a method of presenting a scene according to embodiments of the present disclosure.

As shown in FIG. 3, a method 300 includes operations S310 to S340.

In operation S310, a cubic texture object corresponding to a scene is loaded.

According to embodiments of the present disclosure, each scene corresponds to a cubic texture object. The cubic texture object may be used to indicate a color information of each vertex of a three-dimensional model for the scene.

In operation S320, a vector formed by an observation point of the scene and each vertex of the three-dimensional model is determined.

According to embodiments of the present disclosure, each scene includes an observation point, and the observation point may be used to indicate a position where the user is when observing the scene.

In operation S330, the cubic texture object is sampled according to each vector, so as to obtain a sampling result.

According to embodiments of the present disclosure, for example, for a vector formed by each vertex and the observation point, it is possible to determine an intersection point of the vector and the cubic texture object. Then, a color information corresponding to the intersection point in the cubic texture object may be determined as the sampling result corresponding to the vertex.

In operation S340, a color of each vertex is set according to the sampling result, so as to present the scene.

According to embodiments of the present disclosure, the color of each vertex may be set according to the sampling result corresponding to the vertex, so that attaching a panorama to the three-dimensional model may be achieved, and the scene may be presented.

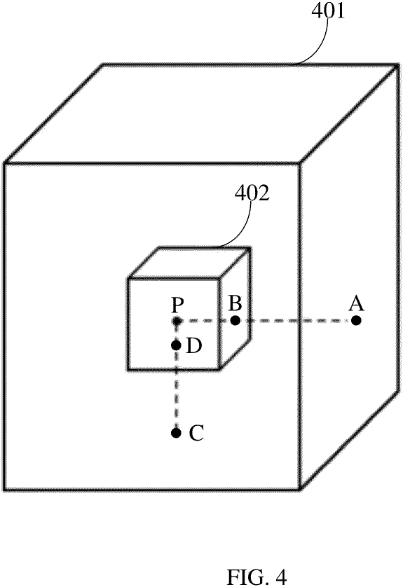

The above-mentioned method of determining the sampling result will be further described with reference to FIG. 4 in combination with specific embodiments. Those skilled in the art may understand that the following exemplary embodiments are merely used for understanding of the present disclosure, and the present disclosure is not limited thereto.

FIG. 4 schematically shows a schematic diagram of determining a sampling result according to embodiments of the present disclosure.

As shown in FIG. 4, for a vertex A of a three-dimensional model 401, it is possible to determine a vector

$$\vec{\text{PA}}$$

(or

$$\vec{\text{AP}} )$$

formed by an observation point P and the vertex A, and an intersection point B of the vector

$$\vec{\text{PA}}$$

(or

$$\vec{\text{AP}} )$$

and a cubic texture 402. Then, a color information corresponding to the point B in the cubic texture 402 may be determined as a sampling result corresponding to the vertex A.

For a vertex C of the three-dimensional model 401, it is possible to determine a vector

$$\vec{\text{PC}}$$

(or

$$\vec{\left(\text{CP}\right)}$$

formed by the observation point P and the vertex C, and an intersection point D of the vector

$$\text{PC}$$

(or

$$\vec{\text{CP}} )$$

and the cubic texture 402. Then, a color information corresponding to the point D in the cubic texture 402 may be determined as a sampling result corresponding to the vertex C.

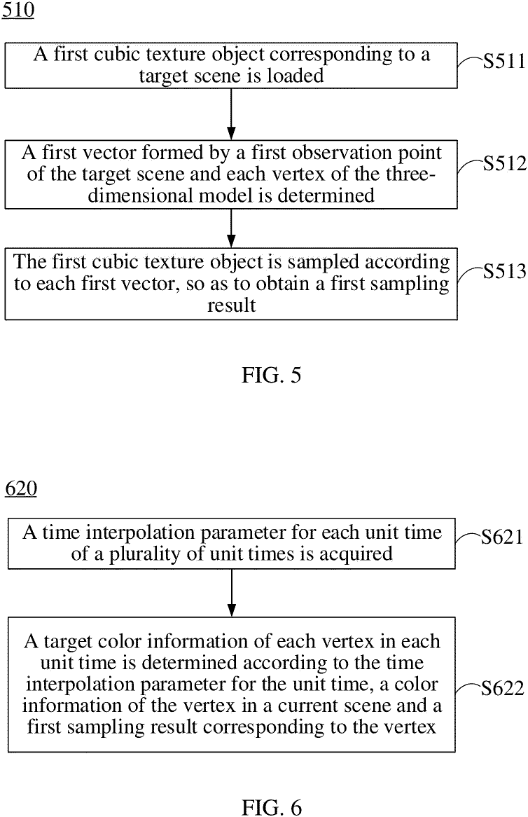

FIG. 5 schematically shows a flowchart of a method of determining a first sampling result corresponding to each vertex of a three-dimensional model according to embodiments of the present disclosure.

As shown in FIG. 5, a method 510 includes operations S511 to S513.

In operation S511, a first cubic texture object corresponding to a target scene is loaded.

In operation S512, a first vector formed by a first observation point of the target scene and each vertex of a three-dimensional model is determined.

In operation S513, the first cubic texture object is sampled according to each first vector, so as to obtain a first sampling result.

According to embodiments of the present disclosure, the method of determining the second sampling result corresponding to each vertex of the three-dimensional model may refer to the above, for example, which will not be repeated here.

FIG. 6 schematically shows a flowchart of a method of determining a roaming animation according to embodiments of the present disclosure.

As shown in FIG. 6, a method 620 includes operations S621 to S622.

In operation S621, a time interpolation parameter for each unit time of a plurality of unit times is acquired.

According to embodiments of the present disclosure, a size and a quantity of the unit time correspond to a duration of the roaming animation, and may be set according to actual needs. The time interpolation parameter may be used to represent, for example, a progress of animation, and may be determined, for example, according to the duration, the unit time and a trajectory of the roaming animation. For example, in such embodiments, the time interpolation parameter may be any value from 0 to 1, where 0 may represent an initial time instant of the roaming animation, and 1 may represent an end time instant of the roaming animation.

In operation S622, a target color information of each vertex in each unit time is determined according to the time interpolation parameter for the unit time, a color information of the vertex in a current scene and a first sampling result corresponding to the vertex.

According to embodiments of the present disclosure, for each unit time, the target color information of each vertex in the unit time may be determined according to:

$$\text{CM} \text{=} \text{C1} ∗ p r o c e s s \text{+} \text{C0} ∗ \left(\text{1} - p r o c e s s\right)$$

where CM represents the target color information of the vertex in the unit time, C1 represents the first sampling result corresponding to the vertex, CO represents the color information of the vertex in the current scene, and process represents the time interpolation parameter for the unit time.

According to embodiments of the present disclosure, after the roaming animation is determined, the color of each vertex may be transformed according to the target color information of the vertex in each unit time, so as to switch the current scene to the target scene.

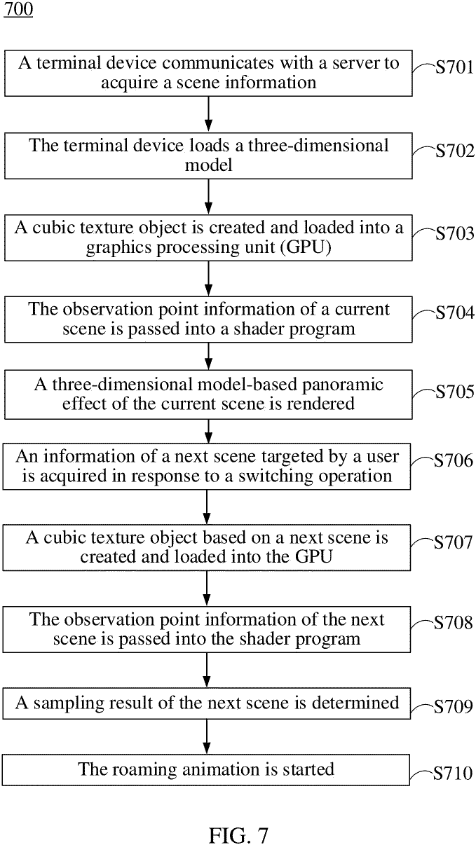

The above-mentioned method of displaying the animation will be further described below with reference to FIG. 7 in combination with specific embodiments. Those skilled in the art may understand that the following exemplary embodiments are merely used for understanding of the present disclosure, and the present disclosure is not limited thereto.

FIG. 7 schematically shows a schematic diagram of a method of displaying an animation according to embodiments of the present disclosure.

As shown in FIG. 7, in operation S701, a terminal device communicates with a server to acquire a scene information. The scene information includes a three-dimensional model information, an observation point information, and a cubic texture information.

In operation S702, the terminal device loads a three-dimensional model.

In operation S703, the terminal device loads a panorama of a current scene by means of CUBE_MAP, that is, creates a cubic texture object CUBE_MAP0 and loads the CUBE_MAP0 into a graphics processing unit (GPU) of the terminal device.

In operation S704, the observation point information of the current scene is passed into a shader program. The observation point information includes, for example, a coordinate P0 (x, y, z) of an observation point P0.

In S705, a three-dimensional model-based panoramic effect of the current scene is rendered.

According to embodiments of the present disclosure, by using a characteristic of the cubic texture (CUBE_MAP), sampling may be performed on a texture according to a vector. Therefore, the CUBE_MAP0 may be sampled by using vector T0 (formed by each vertex of the three-dimensional model and the observation point P0), and a sampling result C0 may be assigned to the vertex of the three-dimensional model. Then, the panorama may be attached to the three-dimensional model to achieve the panoramic effect of the current scene.

In operation S706, an information of a next scene (target scene) targeted by a user is acquired in response to a switching operation. The information of the next scene may include, for example, an observation point information of the next scene and a cubic texture information of the next scene.

According to embodiments of the present disclosure, the switching operation may be triggered by, for example, a user interaction behavior. For example, the user interaction behavior may include clicking on a screen or the like.

In operation S707, similar to operation S703, a cubic texture object CUBE_MAP1 based on the next scene is created and loaded into the GPU.

In operation S708, the observation point information of the next scene is passed into the shader program. The observation point information of the next scene may include, for example, a coordinate P1 (x, y, z) of an observation point P1.

In operation S709, a sampling result of the next scene is determined.

According to embodiments of the present disclosure, similar to operation S705, a vector T1 formed by each vertex of the three-dimensional model and the observation point P1 may be calculated vertex by vertex in the shader program. Then, a texture sampling may be performed on the CUBE_MAP1 by using T1, so as to obtain a sampling result C1.

In S710, the roaming animation is started to switch the current scene to the next scene.

According to embodiments of the present disclosure, the roaming animation may be used to change a camera position, for example, by P0=>P1. The animation may generate a time interpolation parameter process, the process describes a time interpolation ranging from 0 to 1, where 0 may represent an initial time instant of the roaming animation, and 1 may represent an end time instant of the roaming animation. Then, color-mixing may be performed on textures for the two scenes according to the process, that is, a texture color of the three-dimensional model may be set according to

$$\text{CM} \text{=} \text{C1} ∗ p r o c e s s \text{+} \text{C0} ∗ \left(\text{1} - p r o c e s s\right)$$

For example, a duration of the roaming animation may be 2 seconds, and the roaming animation may include five unit times of 0 seconds, 0.5 seconds, 1 seconds, 1.5 seconds, and 2 seconds. In addition, a trajectory of P0=>P1 may be a uniform motion trajectory along a straight line. Based on this, it may be determined that the time interpolation parameters process corresponding to 0 seconds, 0.5 seconds, 1 seconds, 1.5 seconds and 2 seconds are 0, 0.25, 0.5, 0.75 and 1, respectively. According to CM = C1 _{*} process + C0 _{*} (1 - process), it may be calculated that values of the CMs at 0 seconds, 0.5 seconds, 1 seconds, 1.5 seconds and 2 seconds are C0, 0.25*C1 +0.75*C0, 0.5*C1 +0.5*C0, 0.75*C1 +0.25*C0, and C1, respectively. Therefore, when starting the roaming animation, it is possible to set the texture color of the three-dimensional model according to C0 at 0 seconds, set the texture color of the three-dimensional model according to 0.25*C1 +0.75*C0 at 0.5 seconds, set the texture color of the three-dimensional model according to 0.5*C1 +0.5*C0 at 1 seconds, set the texture color of the three-dimensional model according to 0.75*C1 +0.25*C0 at 1.5 seconds, and set the texture color of the three-dimensional model according to C1 at 2 seconds.

During an animation process, a change of the camera may cause a change in a visible part of the three-dimensional model, which in turn causes a change in a texture map, thus causing an image deformation. According to embodiments of the present disclosure, as a start point information and an end point information (i.e., P0 and P1) of the roaming animation are fixed, a degree of deformation caused is consistent with a reality, so that an effect of smooth roaming may be achieved.

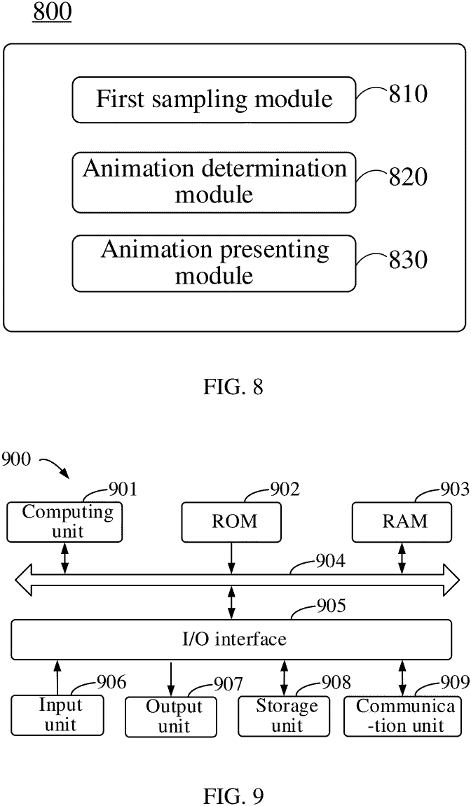

FIG. 8 schematically shows a block diagram of an apparatus of displaying an animation according to embodiments of the present disclosure.

As shown in FIG. 8, an apparatus 800 includes a first sampling module 810, an animation determination module 820, and an animation presenting module 830.

The first sampling module 810 may be used to determine, in response to a scene switching operation for a target scene, a first sampling result corresponding to each vertex of a three-dimensional model according to a first cubic texture object corresponding to the target scene.

The animation determination module 820 may be used to determine a roaming animation according to a color information of each vertex in a current scene and the first sampling result corresponding to each vertex.

The animation presenting module 830 may be used to present the roaming animation so as to switch the current scene to the target scene.

According to embodiments of the present disclosure, the apparatus may further include a loading module, a vector determination module, a second sampling module, and a setting module. The loading module may be used to load a second cubic texture object corresponding to the current scene. The vector determination module may be used to determine a second vector formed by a second observation point of the current scene and each vertex of the three-dimensional model. The second sampling module may be used to sample the second cubic texture object according to each second vector, so as to obtain a second sampling result. The setting module may be used to set a color of each vertex according to the second sampling result, so as to present the current scene.

According to embodiments of the present disclosure, the first sampling module may include a loading sub-module, a vector determination sub-module, and a first sampling sub-module. The loading sub-module may be used to load the first cubic texture object corresponding to the target scene. The vector determination sub-module may be used to determine a first vector formed by a first observation point of the target scene and each vertex of the three-dimensional model. The first sampling sub-module may be used to sample the first cubic texture object according to each first vector, so as to obtain the first sampling result.

According to embodiments of the present disclosure, the animation determination module may include an acquisition sub-module and a color determination sub-module. The acquisition sub-module may be used to acquire a time interpolation parameter for each unit time of a plurality of unit times. The color determination sub-module may be used to determine a target color information of each vertex in each unit time according to the time interpolation parameter for the unit time, a color information of the vertex in the current scene, and the first sampling result corresponding to the vertex.

According to embodiments of the present disclosure, the color determination sub-module may include a calculation unit used to determine, for each unit time, the target color information of each vertex in the unit time according to:

$$\text{CM} \text{=} \text{C1} ∗ p r o c e s s + \text{C0} ∗ \left(1 - p r o c e s s\right) ,$$

where the CM represents the target color information of the vertex in the unit time, the C1 represents the first sampling result corresponding to the vertex, the C0 represents the color information of the vertex in the current scene, and the process represents the time interpolation parameter for the unit time.

According to embodiments of the present disclosure, the animation presenting module may include a transforming sub-module used to transform a color of each vertex according to the target color information of each vertex in each unit time, so as to switch the current scene to the target scene.

According to embodiments of the present disclosure, the present disclosure further provides an electronic device, a readable storage medium, and a computer program product.

FIG. 9 schematically shows a block diagram of an exemplary electronic device 900 for implementing embodiments of the present disclosure. The electronic device is intended to represent various forms of digital computers, such as a laptop computer, a desktop computer, a workstation, a personal digital assistant, a server, a blade server, a mainframe computer, and other suitable computers. The electronic device may further represent various forms of mobile devices, such as a personal digital assistant, a cellular phone, a smart phone, a wearable device, and other similar computing devices. The components as illustrated herein, and connections, relationships, and functions thereof are merely examples, and are not intended to limit the implementation of the present disclosure described and/or required herein.

As shown in FIG. 9, the electronic device 900 includes a computing unit 901 which may perform various appropriate actions and processes according to a computer program stored in a read only memory (ROM) 902 or a computer program loaded from a storage unit 908 into a random access memory (RAM) 903. In the RAM 903, various programs and data necessary for an operation of the electronic device 900 may also be stored. The computing unit 901, the ROM 902 and the RAM 903 are connected to each other through a bus 904. An input/output (I/O) interface 905 is also connected to the bus 904.

A plurality of components in the electronic device 900 are connected to the I/O interface 905, including: an input unit 906, such as a keyboard, or a mouse; an output unit 907, such as displays or speakers of various types; a storage unit 908, such as a disk, or an optical disc; and a communication unit 909, such as a network card, a modem, or a wireless communication transceiver. The communication unit 909 allows the electronic device 900 to exchange information/data with other devices through a computer network such as Internet and/or various telecommunication networks.

The computing unit 901 may be various general-purpose and/or dedicated processing assemblies having processing and computing capabilities. Some examples of the computing unit 901 include, but are not limited to, a central processing unit (CPU), a graphics processing unit (GPU), various dedicated artificial intelligence (Al) computing chips, various computing units that run machine learning model algorithms, a digital signal processing processor (DSP), and any suitable processor, controller, microcontroller, etc. The computing unit 901 executes various methods and steps described above, such as the method of displaying the animation. For example, in some embodiments, the method of displaying the animation may be implemented as a computer software program which is tangibly embodied in a machine-readable medium, such as the storage unit 908. In some embodiments, the computer program may be partially or entirely loaded and/or installed in the electronic device 900 via the ROM 902 and/or the communication unit 909. The computer program, when loaded in the RAM 903 and executed by the computing unit 901, may execute one or more steps in the method of displaying the animation described above. Alternatively, in other embodiments, the computing unit 901 may be configured to perform the method of displaying the animation by any other suitable means (e.g., by means of firmware).

Various embodiments of the systems and technologies described herein may be implemented in a digital electronic circuit system, an integrated circuit system, a field programmable gate array (FPGA), an application specific integrated circuit (ASIC), an application specific standard product (ASSP), a system on chip (SOC), a complex programmable logic device (CPLD), a computer hardware, firmware, software, and/or combinations thereof. These various embodiments may be implemented by one or more computer programs executable and/or interpretable on a programmable system including at least one programmable processor. The programmable processor may be a dedicated or general-purpose programmable processor, which may receive data and instructions from a storage system, at least one input device and at least one output device, and may transmit the data and instructions to the storage system, the at least one input device, and the at least one output device.

Program codes for implementing the methods of the present disclosure may be written in one programming language or any combination of more programming languages. These program codes may be provided to a processor or controller of a general-purpose computer, a dedicated computer or other programmable data processing apparatus, such that the program codes, when executed by the processor or controller, cause the functions/operations specified in the flowcharts and/or block diagrams to be implemented. The program codes may be executed entirely on a machine, partially on a machine, partially on a machine and partially on a remote machine as a stand-alone software package or entirely on a remote machine or server.

In the context of the present disclosure, a machine-readable medium may be a tangible medium that may contain or store a program for use by or in connection with an instruction execution system, an apparatus or a device. The machine-readable medium may be a machine-readable signal medium or a machine-readable storage medium. The machine-readable medium may include, but is not limited to, an electronic, magnetic, optical, electromagnetic, infrared, or semiconductor system, apparatus or device, or any suitable combination of the above. More specific examples of the machine-readable storage medium may include an electrical connection based on one or more wires, a portable computer disk, a hard disk, a random access memory (RAM), a read only memory (ROM), an erasable programmable read only memory (EPROM or a flash memory), an optical fiber, a compact disk read only memory (CD-ROM), an optical storage device, a magnetic storage device, or any suitable combination of the above.

In order to provide interaction with the user, the systems and technologies described here may be implemented on a computer including a display device (for example, a CRT (cathode ray tube) or LCD (liquid crystal display) monitor) for displaying information to the user, and a keyboard and a pointing device (for example, a mouse or a trackball) through which the user may provide the input to the computer. Other types of devices may also be used to provide interaction with the user. For example, a feedback provided to the user may be any form of sensory feedback (for example, visual feedback, auditory feedback, or tactile feedback), and the input from the user may be received in any form (including acoustic input, speech input or tactile input).

The systems and technologies described herein may be implemented in a computing system including back-end components (for example, a data server), or a computing system including middleware components (for example, an application server), or a computing system including front-end components (for example, a user computer having a graphical user interface or web browser through which the user may interact with the implementation of the system and technology described herein), or a computing system including any combination of such back-end components, middleware components or front-end components. The components of the system may be connected to each other by digital data communication (for example, a communication network) in any form or through any medium. Examples of the communication network include a local area network (LAN), a wide area network (WAN), and the Internet.

A computer system may include a client and a server. The client and the server are generally far away from each other and usually interact through a communication network. The relationship between the client and the server is generated through computer programs running on the corresponding computers and having a client-server relationship with each other.

The server may be a cloud server, also known as a cloud computing server or a cloud host, which is a host product in a cloud computing service system to solve shortcomings of difficult management and weak business scalability existing in an existing physical host and VPS (Virtual Private Server) service. The server may also be a server of a distributed system, or a server combined with a block-chain.

It should be understood that steps of the processes illustrated above may be reordered, added or deleted in various manners. For example, the steps described in the present disclosure may be performed in parallel, sequentially, or in a different order, as long as a desired result of the technical solution of the present disclosure may be achieved. This is not limited in the present disclosure.

The above-mentioned specific embodiments do not constitute a limitation on the scope of protection of the present disclosure. Those skilled in the art should understand that various modifications, combinations, sub-combinations and substitutions may be made according to design requirements and other factors. Any modifications, equivalent replacements and improvements made within the spirit and principles of the present disclosure shall be contained in the scope of protection of the present disclosure.

What is claimed is:

1. A method of displaying an animation, the method comprising:
determining, in response to a scene switching operation for a target scene, a first sampling result corresponding to each vertex of a three-dimensional model according to a first cubic texture object corresponding to the target scene;
determining a roaming animation according to a color information of each vertex in a current scene and the first sampling result corresponding to each vertex; and
presenting the roaming animation so as to switch the current scene to the target scene.

2. The method according to claim 1, further comprising:
loading a second cubic texture object corresponding to the current scene;
determining a second vector formed by a second observation point of the current scene and each vertex of the three-dimensional model;
sampling the second cubic texture object according to each second vector, so as to obtain a second sampling result; and
setting a color of each vertex according to the second sampling result, so as to present the current scene.

3. The method according to claim 1, wherein the determining a first sampling result corresponding to each vertex of a three-dimensional model according to a first cubic texture object corresponding to the target scene comprises:
loading the first cubic texture object corresponding to the target scene;
determining a first vector formed by a first observation point of the target scene and each vertex of the three-dimensional model; and
sampling the first cubic texture object according to each first vector, so as to obtain the first sampling result.

4. The method according to claim 3, wherein the determining a roaming animation according to a color information of each vertex in a current scene and the first sampling result corresponding to each vertex comprises:
acquiring a time interpolation parameter for each unit time of a plurality of unit times; and
determining a target color information of each vertex in each unit time according to the time interpolation parameter for the unit time, a color information of the vertex in the current scene and the first sampling result corresponding to the vertex.

5. The method according to claim 4, wherein the determining a target color information of each vertex in each unit time comprises determining, for each unit time, the target color information of each vertex in the unit time according to:
$$\text{CM} \text{=} \text{C1} ∗ p r o c e s s + \text{C0} ∗ \left(1 - p r o c e s s\right) ,$$
wherein CM represents the target color information of the vertex in the unit time, C1 represents the first sampling result corresponding to the vertex, C0 represents the color information of the vertex in the current scene, and process represents the time interpolation parameter for the unit time.

6. The method according to claim 5, wherein the presenting the roaming animation so as to switch the current scene to the target scene comprises transforming a color of each vertex according to the target color information of the vertex in each unit time, so as to switch the current scene to the target scene.

7. The method according to claim 2, wherein the determining a first sampling result corresponding to each vertex of a three-dimensional model according to a first cubic texture object corresponding to the target scene comprises:
loading the first cubic texture object corresponding to the target scene;
determining a first vector formed by a first observation point of the target scene and each vertex of the three-dimensional model; and
sampling the first cubic texture object according to each first vector, so as to obtain the first sampling result.

8. An electronic device, comprising:
at least one processor; and
a memory communicatively connected to the at least one processor, wherein the memory stores instructions executable by the at least one processor, and the instructions, when executed by the at least one processor, cause the at least one processor to at least:
determine, in response to a scene switching operation for a target scene, a first sampling result corresponding to each vertex of a three-dimensional model according to a first cubic texture object corresponding to the target scene;
determine a roaming animation according to a color information of each vertex in a current scene and the first sampling result corresponding to each vertex; and
present the roaming animation so as to switch the current scene to the target scene.

9. The electronic device according to claim 8, wherein the instructions are further configured to cause the at least one processor to at least:
load a second cubic texture object corresponding to the current scene;
determine a second vector formed by a second observation point of the current scene and each vertex of the three-dimensional model;
sample the second cubic texture object according to each second vector, so as to obtain a second sampling result; and
set a color of each vertex according to the second sampling result, so as to present the current scene.

10. The electronic device according to claim 8, wherein the instructions are further configured to cause the at least one processor to at least:
load the first cubic texture object corresponding to the target scene;
determine a first vector formed by a first observation point of the target scene and each vertex of the three-dimensional model; and
sample the first cubic texture object according to each first vector, so as to obtain the first sampling result.

11. The electronic device according to claim 10, wherein the instructions are further configured to cause the at least one processor to at least:
acquire a time interpolation parameter for each unit time of a plurality of unit times; and
determine a target color information of each vertex in each unit time according to the time interpolation parameter for the unit time, a color information of the vertex in the current scene and the first sampling result corresponding to the vertex.

12. The electronic device according to claim 11, wherein the instructions are further configured to cause the at least one processor to at least determine, for each unit time, the target color information of each vertex in the unit time according to:
$$\text{CM} \text{=} \text{C1} ∗ p r o c e s s + \text{C0} ∗ \left(1 - p r o c e s s\right) ,$$
wherein CM represents the target color information of the vertex in the unit time, C1 represents the first sampling result corresponding to the vertex, C0 represents the color information of the vertex in the current scene, and process represents the time interpolation parameter for the unit time.

13. The electronic device according to claim 12, wherein the instructions are further configured to cause the at least one processor to at least transform a color of each vertex according to the target color information of the vertex in each unit time, so as to switch the current scene to the target scene.

14. The electronic device according to claim 9, wherein the instructions are further configured to cause the at least one processor to at least:
load the first cubic texture object corresponding to the target scene;
determine a first vector formed by a first observation point of the target scene and each vertex of the three-dimensional model; and
sample the first cubic texture object according to each first vector, so as to obtain the first sampling result.

15. A non-transitory computer-readable storage medium having computer instructions therein, wherein the computer instructions are configured to cause a computer system to at least:
determine, in response to a scene switching operation for a target scene, a first sampling result corresponding to each vertex of a three-dimensional model according to a first cubic texture object corresponding to the target scene;
determine a roaming animation according to a color information of each vertex in a current scene and the first sampling result corresponding to each vertex; and
present the roaming animation so as to switch the current scene to the target scene.

16. The non-transitory computer-readable storage medium according to claim 15, wherein the instructions are further configured to cause the computer system to at least:
load a second cubic texture object corresponding to the current scene;
determine a second vector formed by a second observation point of the current scene and each vertex of the three-dimensional model;
sample the second cubic texture object according to each second vector, so as to obtain a second sampling result; and
set a color of each vertex according to the second sampling result, so as to present the current scene.

17. The non-transitory computer-readable storage medium according to claim 15, wherein the instructions are further configured to cause the computer system to at least:
load the first cubic texture object corresponding to the target scene;
determine a first vector formed by a first observation point of the target scene and each vertex of the three-dimensional model; and
sample the first cubic texture object according to each first vector, so as to obtain the first sampling result.

18. The non-transitory computer-readable storage medium according to claim 17, wherein the instructions are further configured to cause the computer system to at least:
acquire a time interpolation parameter for each unit time of a plurality of unit times; and
determine a target color information of each vertex in each unit time according to the time interpolation parameter for the unit time, a color information of the vertex in the current scene and the first sampling result corresponding to the vertex.

19. The non-transitory computer-readable storage medium according to claim 18, wherein the instructions are further configured to cause the computer system to at least determine, for each unit time, the target color information of each vertex in the unit time according to:
$$\text{CM=C1} ∗ p r o c e s s + \text{C0} ∗ \left(1 - p r o c e s s\right) ,$$
wherein CM represents the target color information of the vertex in the unit time, C1 represents the first sampling result corresponding to the vertex, C0 represents the color information of the vertex in the current scene, and process represents the time interpolation parameter for the unit time.

20. The non-transitory computer-readable storage medium according to claim 19, wherein the instructions are further configured to cause the computer system to at least transform a color of each vertex according to the target color information of the vertex in each unit time, so as to switch the current scene to the target scene.
